(19) United States
(12) Patent Application Publication
(10) Pub. No.: US 2013/0248772 A1
(43) Pub. Date: Sep. 26, 2013

(54) SECONDARY BATTERY

(71) Applicant: Hyunuk Jo, Yongin-si (KR)

(72) Inventor: Hyunuk Jo, Yongin-si (KR)

(73) Assignee: SAMSUNG SDI CO., LTD., Yongin-si (KR)

(21) Appl. No.: 13/563,418

(22) Filed: Jul. 31, 2012

(30) Foreign Application Priority Data
Mar. 26, 2012 (KR) 10-2012-0030573

(51) Int. Cl. H01B 1/04; H01M 4/62; H01M 4/583; B82Y 30/00

(52) U.S. Cl. 252/503; 429/231.8; 252/502; 977/742; 977/734; 977/750; 977/752

(57) ABSTRACT

Provided is a secondary battery which has improved high-rate discharge characteristic and cycle life characteristic and an improved binding strength of an active material. The secondary battery includes an electrode having an active material, a conductive agent and a binder. The conductive agent includes a first carbon nano conductive agent having a first diameter, and a second carbon nano conductive agent having a second diameter greater than the first diameter.

### CLAIM OF PRIORITY

This application makes reference to, incorporates the same herein, and claims all benefits accruing under 35 U.S.C. §119 from an application earlier filed in the Korean Intellectual Property Office on 26 Mar. 2012 and there duly assigned Serial No. 10-2012-0030573.

### BACKGROUND OF THE INVENTION

1. Field of the Invention

An embodiment of the present invention relates to a secondary battery, and more specifically, to a secondary battery having improved high-rate discharge characteristic and cycle life characteristic and an improved binding strength of an active material.

2. Description of the Related Art

The lithium ion battery is one kind of secondary batteries. In a lithium ion battery, lithium ions move from a negative electrode to a positive electrode during a discharge operation, and the lithium ions move from a positive electrode to a negative electrode during a charge operation. The lithium ion battery is widely used in portable electronic devices, because the lithium ion battery has a higher energy density, eliminates a memory effect, and is lower in natural discharge rate when the lithium ion battery is not in use. In addition, the lithium ion battery is used more and more frequently in various application fields, including electronic tools, electric bicycles, electric motorcycles, electric automobiles, airplanes and so on because of its high energy density.

The lithium ion battery may be mainly composed of a positive electrode, a negative electrode and an electrolyte, which may be made of a variety of materials. For example, graphite is most widely used as a negative electrode material on a commercial basis. A lamellar type lithium cobalt oxide or a lithium manganese oxide is generally used as a positive electrode material. The voltage, cycle life, capacity and stability of a battery may vary greatly in accordance with the materials used in the positive and negative electrodes and the electrolyte.

The capacity of a battery may be indicated in milliampere-hours (mAh) or ampere-hours (Ah). The capacity of the battery used in a cellular phone is usually in a range of approximately 800 to 1000 mAh, and the capacity of the battery used in a smart phone is in a range of approximately 1100 to 1950 mAh. The capacity of the battery used in a notebook computer is in a range of approximately 2400 to 5500 mAh.

### SUMMARY OF THE INVENTION

Aspects of the present invention provide a secondary battery which can improve the high-rate discharge characteristic and the cycle life characteristic and the binding strength of an active material.

In accordance with one embodiment the present invention, a secondary battery may include an electrode having an active material, a conductive agent and a binder. The conductive agent may include a first carbon nano conductive agent having a first diameter, and a second carbon nano conductive agent having a second diameter greater than the first diameter.

A diameter ratio of the first diameter to the second diameter may range from 1:2 to 1:10.

A diameter ratio of the first diameter to the second diameter may range from 1:2 to 1:6.

The first and second carbon nano conductive agents may have the first and second diameters ranging from 1 nm to 200 nm, respectively.

The first diameter may be in a range of 5 nm to 50 nm and the second diameter may be in a range of 10 nm to 150 nm.

The first and second carbon nano conductive agents may have an aspect ratio of 1 or greater.

The first and second carbon nano conductive agents may include carbon nano tubes, carbon nano fibers or mixtures thereof.

The first and second carbon nano conductive agents may include single-walled carbon nanotubes (SWNTs), multi-walled carbon nanotubes (MTWNTs), cup-stack type MTWNTs or mixtures thereof.

The secondary battery may further include an additional conductive agent selected from the group consisting of natural graphite, artificial graphite, carbon black, acetylene black, ketjen black, carbon fiber, copper, nickel, aluminum, silver, polyphenylene derivatives and combinations thereof, and a mixing ratio of the first and second carbon nano conductive agents and the additional conductive agent may range from 1:1 to 1:10.

The first carbon nano conductive agent may have a specific surface area of 50 to 500 m²/g, and the second carbon nano conductive agent may have a specific surface area of less than 300 m²/g.

A Raman ratio of the first and second carbon nano conductive agents may be in a range of 0.01 to 2.

The first and second carbon nano conductive agents may have a purity of greater than 85%.

The first carbon nano conductive agent may have a specific weight of 0.01 to 0.1 g/cm³, and the second carbon nano conductive agent may have a specific weight of 0.005 to 0.01 g/cm³.

The first carbon nano conductive agent may have specific resistance of 0.01 to 0.03 Ω·cm, and the second carbon nano conductive agent may have specific resistance of 0.01 to 0.1 Ω·cm.

The conductive agent may be contained in an amount of less than 10 wt % based on the total weight of the electrode.

The secondary battery may further include an additional conductive agent selected from the group consisting of natural graphite, artificial graphite, carbon black, acetylene black, ketjen black, carbon fiber, copper, nickel, aluminum, silver, polyphenylene derivatives and combinations thereof, and the additional conductive agent is contained in an amount of less than 10 wt % based on the total weight of the electrode.

The first and second carbon nano conductive agents may be contained in an amount of 1 to 90 wt % based on the total weight of the conductive agent.

The first carbon nano conductive agent may be dispersed on a surface of the active material and the second carbon nano conductive agent may be dispersed between active materials to form a network of electrical conduction.

In accordance with an embodiment of the present invention, the conductive agent for an electrode of a secondary battery may include a first carbon nano conductive agent which has a first diameter and is dispersed on a surface of an active material and a second carbon nano conductive agent which has a second diameter and is positioned between molecules of active material and forms a micro network of electrical conduction. Such conductive agent reduces the electrical resistance of the active material and improves the binding strength of the active material.

In addition, the conductive agent for the electrode of a secondary battery constructed with an embodiment of the present invention serves to perform a conducting function like the contemporary conductive agent and improves the binding strength between active materials and between an active material and a current collector, thereby improving the high-rate discharge characteristic and the cycle life characteristics. In addition, a proportion of separating or releasing the active material from the electrode may be noticeably reduced.

Additional aspects and/or advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram showing a conductive agent for a secondary battery constructed with an embodiment of the present invention;

FIG. 2 is a schematic diagram showing an electrode for a secondary battery constructed with another embodiment of the present invention;

FIGS. 3A and 3B are microscopic photographic images of a conductive agent composed of a first carbon nano conductive agent and a second carbon nano conductive agent for a secondary battery constructed with an embodiment of the present invention;

FIGS. 4A and 4B are microscopic photographic images of a first carbon nano conductive agent as a conductive agent for a secondary battery constructed with an embodiment of the present invention; and

FIGS. 5A and 5B are microscopic photographic images of a second carbon nano conductive agent as a conductive agent for a secondary battery constructed with an embodiment of the present invention.

### DETAILED DESCRIPTION OF THE INVENTION

Hereinafter, embodiments of the present invention will be described in detail with reference to the accompanying drawings.

In general, a conductive agent used in an electrode of a secondary battery may serve to increase the electrical conductivity of the electrode. In an embodiment, when a positive or negative electrode of a secondary battery is manufactured, a positive active material or a negative active material is mixed with a binder to be prepared in a paste type. Here, even though the positive active material or the negative active material itself has an electrical conductivity to a certain extent, a conductive agent may be added to further increase the electrical conductivity of the positive active material or the negative active material. The conductive agent promotes the movement of electrons generated by an electrochemical reaction, and may affect the high-rate discharge and the cycle life characteristics of the secondary battery.

Meanwhile, when a carbon nano conductive agent is used as a conductive agent of an electrode, the electrical resistance of the electrode may be reduced because the carbon nano conductive agent has a relatively small electrical resistance. If the conventional conductive agent is simply replaced by a single kind of carbon nano conductive agent, however, the performance of the battery is enhanced only for a short time period. More specifically, when a single kind of carbon nano conductive agent is used as a conductive agent, the deformation of the electrode due to shrinkage or expansion of the electrode is unable to be effectively suppressed. In addition, since the binding strength of the electrode is degraded, long time period maintenance of the electrode may not be achieved. Here, the binding strength means binding strength between the active materials and/or binding strength between an active material and a current collector.

Unlike carbon black based spherical particles, the carbon nano conductive agent has a structure of a thin, long tube or fiber. When the carbon nano conductive agent is added to a positive or negative electrode as a conductive agent, the carbon nano conductive agent is appropriately dispersed to be adsorbed into a surface of an active material in the electrode or exist between active materials.

When the carbon nano conductive agent is dispersed well in the electrode, the binding strength and performance of the active material may increase due to an increase in the surface area of the active material contacting the carbon nano conductive agent. If dispersion efficiency is lowered due to Van der Waals interaction, however, the carbon nano conductive agent existing in an agglomerated form, rather than being dispersed and existing on the surface of the active material, may cause degradation in the binding strength and performance of the active material due to a reduced surface area of the active material. Here, methods for improving the dispersing force and efficiency of the carbon nano conductive agent are known in the art, and descriptions thereof will not be given.

In accordance with an embodiment of the present invention which improves the binding strength and the performance of the active material by increasing the dispersion of the carbon nano conductive agent in the electrode and by determining the diameter or thickness of the carbon nano conductive agent, the electrode of a secondary battery includes a conductive agent prepared by mixing a first carbon nano conductive agent having a first diameter and a second carbon nano conductive agent having a second diameter. No research has been yet reported up to now to attempt to improve the performance of the electrode by increasing diameter dependent physical effects using a carbon nano conductive agent operating in an electrode.

For brevity of explanation, it is assumed that the second diameter is greater than the first diameter. Since the first carbon nano conductive agent having the first diameter that is relatively small is dispersed or present on a surface of an active material, electric resistance on the surface of the active material (for a positive or negative electrode) is reduced, thereby facilitating movement of lithium ions. In addition, since a matching area between active materials is increased, the binding strength between the active materials is improved. Furthermore, the second carbon nano conductive agent having the second diameter that is relatively large forms a network of electrical conduction between the active materials and is bonded to the active materials, thereby inhibiting deterioration of the binding strength due to shrinkage or expansion of electrode of the battery and improving the high-rate discharge characteristic and cycle life characteristic of the battery.

That is to say, if the binding strength between active materials or the binding strength between an active material and a current collector is increased, the electrical resistance between the active materials and the electrical resistance between the active material and the current collector are reduced. Therefore, the secondary battery including such an electrode may naturally have improved high-rate discharge characteristic and cycle life characteristic.

The present invention will now be described in reference to the drawings.

FIG. 1 is a schematic diagram showing a conductive agent for a secondary battery constructed with an embodiment of the present invention.

As shown in FIG. 1, the conductive agent 100 for a secondary battery constructed with an embodiment of the present invention includes a first carbon nano conductive agent 110 having a first diameter, and a second carbon nano conductive agent 120 having a second diameter greater than the first diameter.

Here, a mixing ratio by weight of the first carbon nano conductive agent 110 to the second carbon nano conductive agent 120 may range from approximately 1:0.2 to approximately 1:5.

If the mixing ratio by weight is less than approximately 1:0.2, the high-rate discharge and cycle life characteristics and the binding strength of the electrode may be lowered. Even if the mixing ratio by weight is greater than approximately 1:5, the high-rate discharge and cycle life characteristics and the binding strength of the electrode are not further increased. Therefore, it is not necessary to exceed the above range of the mixing ratio.

In addition, a diameter ratio of the first diameter to the second diameter may range from approximately 1:2 to approximately 1:10. Preferably, the diameter ratio of the first diameter to the second diameter may range from approximately 1:2 to approximately 1:6. In addition, the first and second carbon nano conductive agents 110 and 120 have diameters ranging from approximately 1 nm to approximately 200 nm, preferably from approximately 5 nm to approximately 150 nm, and more preferably from approximately 10 nm to approximately 100 nm, respectively.

In more detail, the first diameter of the first carbon nano conductive agent 110 may be in a range of approximately 1 nm to approximately 50 nm, preferably approximately 5 nm to approximately 50 nm, and more preferably approximately 10 nm to approximately 30 nm. The second diameter of the second carbon nano conductive agent 120 may be in a range of 10 nm to 150 nm, preferably in a range of approximately 20 nm to approximately 130 nm, and more preferably in a range of approximately 30 nm to approximately 100 nm.

Further, the first and second carbon nano conductive agents 110 and 120 may have an aspect ratio of 1 or greater.

Numerical values listed herein are provided only for a better understanding of the present invention, and aspects of the present invention are not limited thereto. That is to say, since experiments of the present invention were carried out within ranges of such numerical values, particular numerical values are just illustrated but are not intended to limit the scope of the present invention to those illustrated herein.

In addition, the first and second carbon nano conductive agents 110 and 120 have different specific surface areas according to the diameter and length thereof. The diameters of the first and second carbon nano conductive agents 110 and 120 according to the present invention are much smaller than approximately 100 μm, however, the specific surface areas thereof vary according to the diameters thereof. That is to say, the specific area of the first carbon nano conductive agent 110 may be in a range of approximately 50 to approximately 500 m²/g, preferably in a range of approximately 100 to 400 m²/g, and more preferably in a range of approximately 150 to 350 m²/g. In addition, the specific area of the second carbon nano conductive agent 120 may be less than approximately 300 m²/g, preferably less than approximately 200 m²/g, and more preferably less than approximately 150 m²/g. That is to say, the larger the diameter of the carbon nano conductive agent is, the smaller the specific surface area thereof becomes. Although the carbon nano conductive agent has slightly different specific surface areas according to the manufacturing process or characteristics thereof, the carbon nano conductive agent generally has the diameter-to-surface area relationship as stated above. Therefore, when a user intends to buy a carbon nano conductive agent, it is recommendable for the user to select an appropriate carbon nano conductive agent in the range stated above by referring to a data sheet of the carbon nano conductive agent.

The high-rate discharge and cycle life characteristics of the secondary battery are affected by the specific surface area of the carbon nano conductive agent. That is to say, the larger the specific surface area of the carbon nano conductive agent is, the more the carbon nano conductive agent is dispersed and present on a surface of the active material. Accordingly, the electrical resistance on the surface of the active material is further reduced, thereby further facilitating movement of lithium ions. The facilitated movement of lithium ions suggests that the high-rate discharge characteristic of the secondary battery is improved. In addition, the improved high-rate discharge characteristic suggests that a high-rate charge characteristic of the secondary battery is also improved, thereby reducing a capacity reduction relative to charge/discharge cycles and ultimately improving the cycle life characteristic.

Meanwhile, the first and second carbon nano conductive agents used in the present invention preferably have a purity of greater than approximately 85%. If the purity levels of the first and second carbon nano conductive agents do not exceed the range stated above, high-rate discharge and cycle life characteristics of the secondary battery may not be improved due to impurity.

In addition, the first and second carbon nano conductive agents used in the present invention have the following physical properties. In an exemplary embodiment, the first and second carbon nano conductive agents have a Raman ratio, i.e., the intensity ratio of D-band to G-band (D/G) as an index for the purity, is preferably in a range of 0.01 to 2. In addition, the first carbon nano conductive agent has a specific weight in a range of 0.01 to 0.1 g/cm³, while the second carbon nano conductive agent has a specific weight in a range of 0.005 to 0.01 g/cm³. In addition, the first carbon nano conductive agent has specific resistance in a range of 0.01 to 0.03 Ω·cm, while the second carbon nano conductive agent has specific resistance in a range of 0.01 to 0.1 Ω·cm.

In practice, as described above, the first and second carbon nano conductive agents should meet the range requirements stated above in view of purity and Raman ratio. If the first and second carbon nano conductive agents do not meet the range requirements of purity and Raman ratio, it is difficult to improve the high-rate discharge and cycle life characteristics of the secondary battery and the binding strength of the active material.

Meanwhile, the specific surface area, specific weight and specific resistance, other than the purity and Raman ratio, are automatically changed values according to the diameter. Basically, the larger the carbon nano conductive agent is, the smaller the specific surface area and specific weight become and the larger the specific resistance becomes. The carbon nano conductive agent however may not demonstrate a significant difference in the specific resistance according to the manufacturing process thereof.

In addition, the first and second carbon nano conductive agents 110 and 120 may include carbon nano tubes, carbon nano fibers or mixtures thereof. In an exemplary embodiment, the first and second carbon nano conductive agents 110 and 120 may include single-walled carbon nanotubes (SWNTs), multi-walled carbon nanotubes (MTWNTs), cup-stack type MTWNTs or mixtures thereof. The present invention however does not limit the kinds or types of the first and second carbon nano conductive agents 110 and 120. In addition, since the SWNT, MTWNT and cup-stack type MTWNT are well known in the art, detailed descriptions thereof will not be given.

Meanwhile, the conductive agent 100 according to an embodiment of the present invention may further include additional conductive agent selected from the group consisting of natural graphite, artificial graphite, carbon nano fiber, carbon black, acetylene black, ketjen black, and metal powder of copper, nickel, aluminum or silver.

The first and second carbon nano conductive agents 110, 120 and the additional conductive agent may be mixed in a ratio of approximately 1:1 to approximately 1:10. If the first and second carbon nano conductive agents 110 and 120 and the additional conductive agent are mixed in a mixing ratio deviating from the range stated above, the high-rate discharge and cycle life characteristics of the secondary battery and the binding strength of active material are generally lowered.

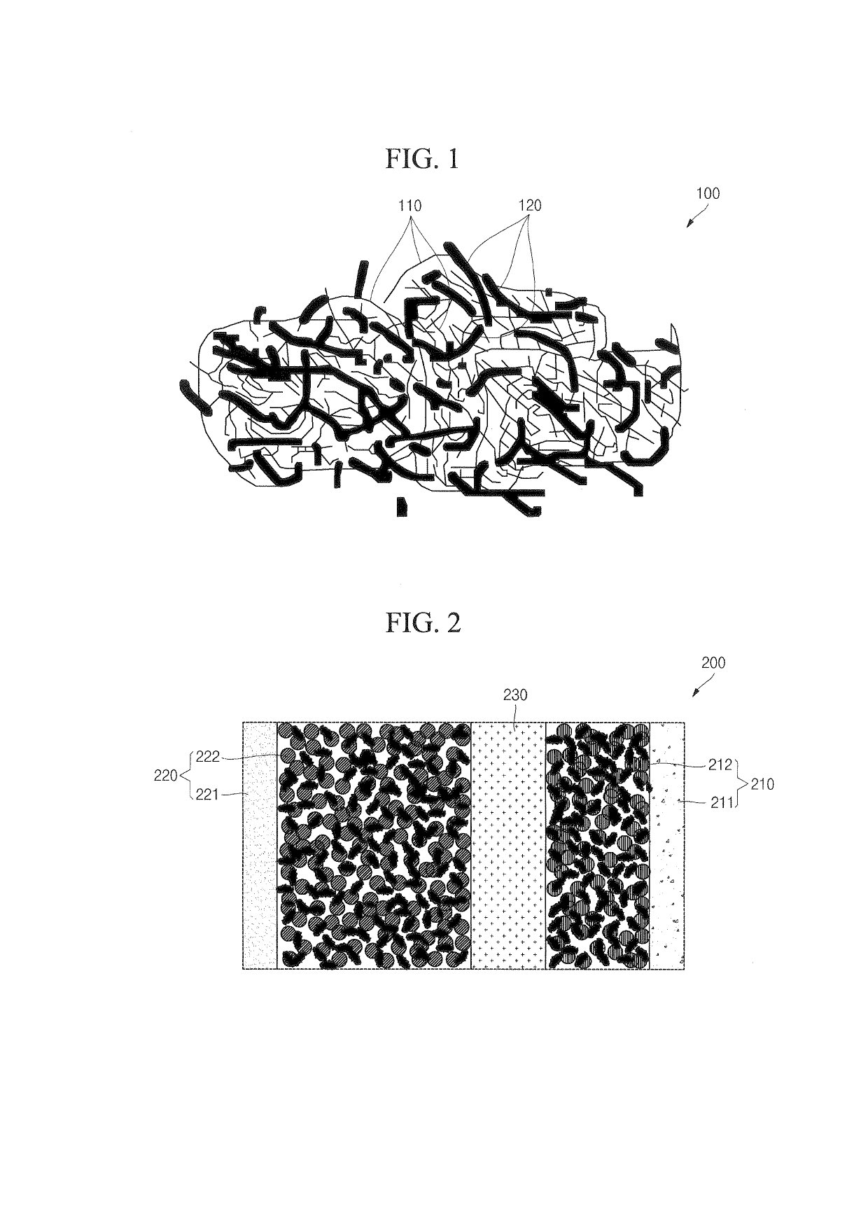

FIG. 2 is a schematic diagram showing an electrode for a secondary battery constructed with another embodiment of the present invention.

As shown in FIG. 2, the electrode 200 includes a negative electrode 210 and a positive electrode 220. More specifically, the negative electrode 210 includes a negative electrode current collector 211 and a negative active material 212, and the positive electrode 220 includes a positive electrode current collector 221 and a positive active material 222. Here, the negative electrode current collector 211 may be made of copper, and the positive electrode current collector 221 may be made of aluminum.

In addition, the negative active material 212 includes graphite and further includes a conductive agent and a binder. More specifically, the negative active material 212 may include a crystalline carbon, an amorphous carbon or a combination thereof. Here, examples of the crystalline carbon may include graphite such as natural graphite or artificial graphite that is in a shapeless, disk-shaped, flaked, globular or fibrous form, or a mixed form thereof. Examples of the amorphous carbon may include soft carbon (low-temperature sintered carbon), hard carbon, mesophase pitch carbide, or sintered cokes.

In addition, the negative active material may be a material selected from the group consisting of Si, SiOₓ (0<x≦2), Sn, SnO₂, Si-containing metal alloys, and mixtures thereof. Here, the metal capable of forming Si alloys may include at least one selected from Al, Sn, Ag, Fe, Bi, Mg, Zn, in, Ge, Pb and Ti.

In addition, any material having a layered crystal structure to be capable of reversibly intercalating and deintercalating lithium ions between layers may be used as a negative active material.

The positive active material 222 includes lithium cobalt oxide (LiCoO₂) and further includes a conductive agent and a binder. Specific examples of the positive electrode active material 222 may include at least one include at least one selected from the group consisting of lithium cobalt oxide (LiCoO₂); lithium nickel oxide (LiNiO₂); lithium manganese oxide (Li₁₊ₓMn₂₋ₓO₄, where x is in a range of from 0 to 0.33), LiMnO₃, LiMn₂O₃, or LiMnO₂; lithium copper oxide (Li₂CuO₂); lithium iron oxide (LiFe₃O₄); lithium vanadium oxide (LiV₃O₈); copper vanadium oxide (Cu₂V₂O₇); vanadium oxide (V₂O₅); Ni-site lithium nickel oxide (LiNi₁₋MₓO₂, where M=Co, Mn, Al, Cu, Fe, Mg, B or Ga and x=0.01˜0.3); lithium manganese composite oxide (LiMn₂₋ₓMₓO₂, where M=Co, Ni, Fe, Cr, Zn or Ta and x=0.01˜0.1 or Li₂Mn₃MO₈, where M=Fe, Co, Ni, Cu or Zn); lithium manganese oxide where the Li of LiMn₂O₄ is partially substituted with alkaline-earth metal ion; disulfide compound; iron molybdenum oxide (Fe₂(MoO₄)₃); chromium oxide (Cr₂O₃) or (Cr₃O₈); iron vanadium oxide (FeVO₄); TiS₂, FeS₂, Nb₃S₄ and FeOCl.

The positive electrode active material 222 may include any material that allows reversible intercalation and deintercalation of lithium ions (lithiated intercalation compound). In addition, a porous separator 230 is interposed between the negative electrode 210 and the positive electrode 220. In an exemplary embodiment, the separator 230 may be a porous polyolefin based separator or a ceramic separator. The polyolefin based separator may include a polypropylene (PP)/polyethylene (PE)/PP 3-layered separator having a cylinder type pore structure, or a single layered PE having a mesh pore structure. The ceramic separator may be a separator prepared by coating ceramic on a surface of the polyolefin based separator or on a surface of a nonwoven fabric. Here, the ceramic may include alumina as a main component.

In addition, although not illustrated, non-limiting examples of suitable electrolytes include aprotic solvents selected from the group consisting of propylene carbonate, ethylene carbonate, butylene carbonate, benzonitrile, acetonitrile, tetrahydrofuran, 2-methyl tetrahydrofuran, y-butyrolactone, dioxolane, 4-methyl dioxolane, N,N-dimethyl formamide, dimethyl acetamide, dimethyl sulfoxide, dioxane, 1,2-dimethoxy ethane, sulfolane, dichloroethane, chlorobenzene, nitrobenzene, dimethyl carbonate, methylethyl carbonate, diethyl carbonate, methylpropyl carbonate, methylisopropyl carbonate, ethylbutyl carbonate, dipropyl carbonate, diisopropyl carbonate, dibutyl carbonate, diethylene glycol, dimethyl ether, and mixtires of two or more of such solvents with two or more electrolytes having lithium salts selected from LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CxF₂ₓ+SO₂) (CyF_{2y+1}SO₂) wherein x and y are natural numbers, LiCl, and LiI.

As described above, the electrode for a secondary battery includes an active material, a conductive agent and binder. The conductive agent includes a first carbon nano conductive agent having a first diameter, and a second carbon nano conductive agent having a second diameter greater than the first diameter. The conductive agent is substantially the same as that described above, and descriptions thereof will be mostly omitted.

The conductive agent however may be contained in an amount of less than approximately 10 wt % based on the total weight of the electrode. The conductive agent further includes an additional conductive agent selected from the group consisting of natural graphite, artificial graphite, carbon black, acetylene black, ketjen black, carbon fiber, copper, nickel, aluminum, silver, polyphenylene derivatives and combinations thereof, and the additional conductive agent may be contained in an amount of less than approximately 10 wt % based on the total weight of the electrode. In addition, the first and second carbon nano conductive agents may be contained in an amount of 1 to 90 wt % based on the total weight of the conductive agent. If the first and second carbon nano conductive agents are contained in an amount deviating from the range stated above, an amount of the active material or the conductive agent is relatively reduced, thereby adversely affecting the performance of the secondary battery.

The first carbon nano conductive agent is generally dispersed and present on a surface of the active material and the second carbon nano conductive agent is generally positioned between the active materials to form a micro network of electrical conduction.

As described above, since the conductive agent for a secondary battery is composed of the first carbon nano conductive agent which has a first diameter and is generally dispersed on the surface of the active material and the second carbon nano conductive agent which has a second diameter and is generally positioned between the active materials to form a micro network of electrical conduction, the electrical resistance of active material may be reduced while the binding strength of the active material is improved. As described above, the binding strength means binding strength between active materials and/or binding strength between an active material and a current collector.

In addition, the conductive agent for the electrode of a secondary battery constructed with an embodiment of the present invention serves to perform a conducting function like the conventional conductive agent and improves binding strength between active materials and between an active material and a current collector, thereby improving high-rate discharge and cycle life characteristics. In addition, in accordance with an embodiment of the present invention, a proportion of separating or releasing the active material from the electrode may be reduced.

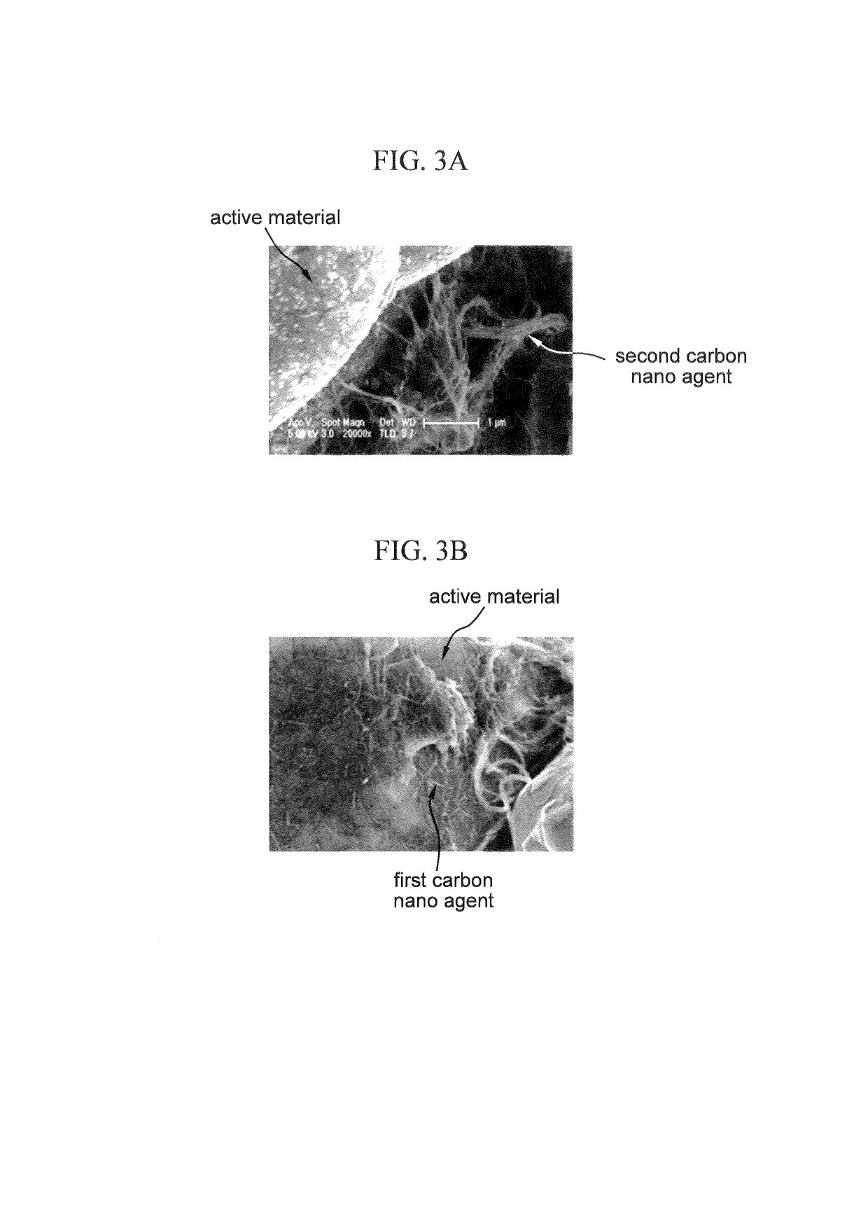

FIGS. 3A and 3B are microscopic photographic images of a conductive agent composed of a first carbon nano conductive agent and a second carbon nano conductive agent for a secondary battery according to an embodiment of the present invention.

As shown in FIGS. 3A and 3B, the first carbon nano conductive agent is generally dispersed on the surface of active material, and the second carbon nano conductive agent is generally dispersed between active materials. That is to say, the first carbon nano conductive agent having the first diameter that is relatively small is generally dispersed on the surface of active material and the second carbon nano conductive agent having the second diameter that that is relatively large is generally dispersed at exterior sides of active material, thereby forming a network of electric conduction between the active materials.

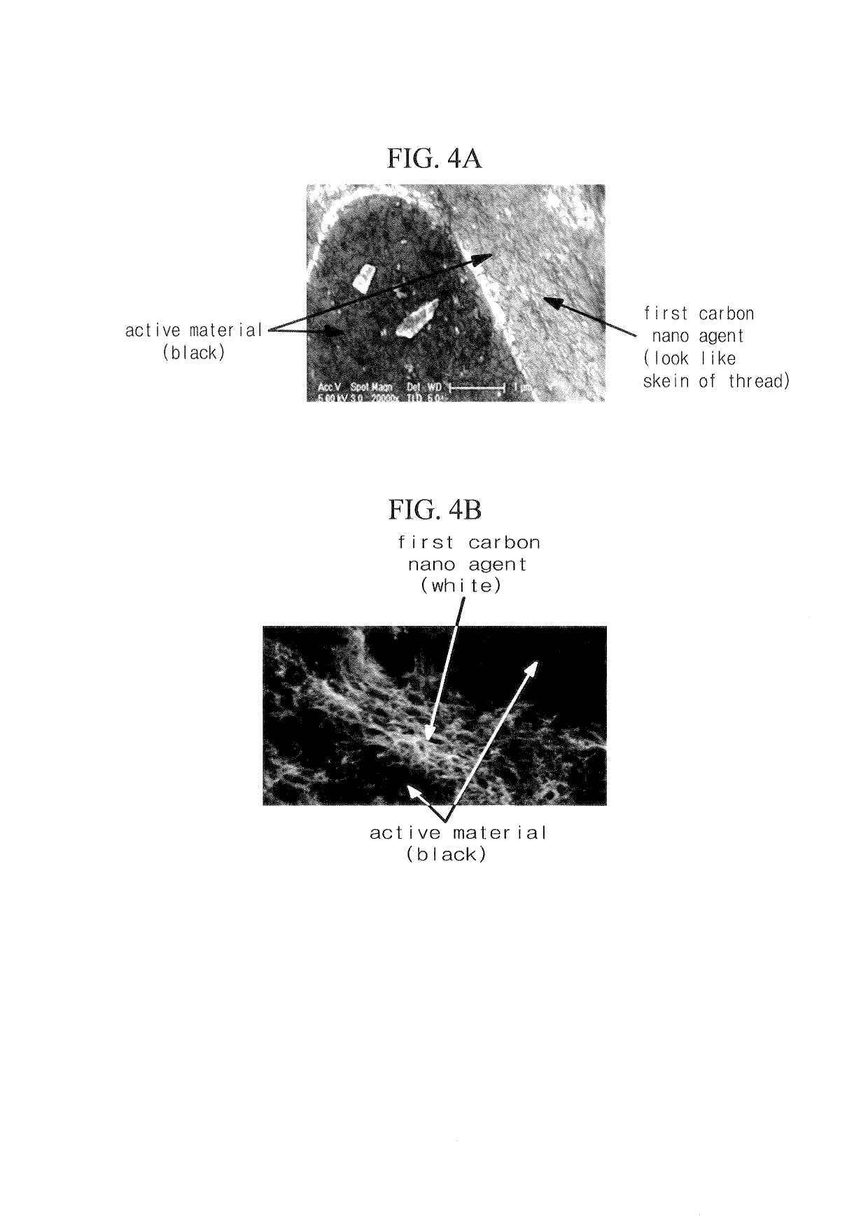

FIGS. 4A and 4B are microscopic photographic images of a first carbon nano conductive agent as a conductive agent for a secondary battery constructed with an embodiment of the present invention.

As shown in FIGS. 4A and 4B, the first carbon nano conductive agent is generally dispersed on the surface of active material. That is to say, the first carbon nano conductive agent having the first diameter that is relatively small is generally dispersed on the surface of active material.

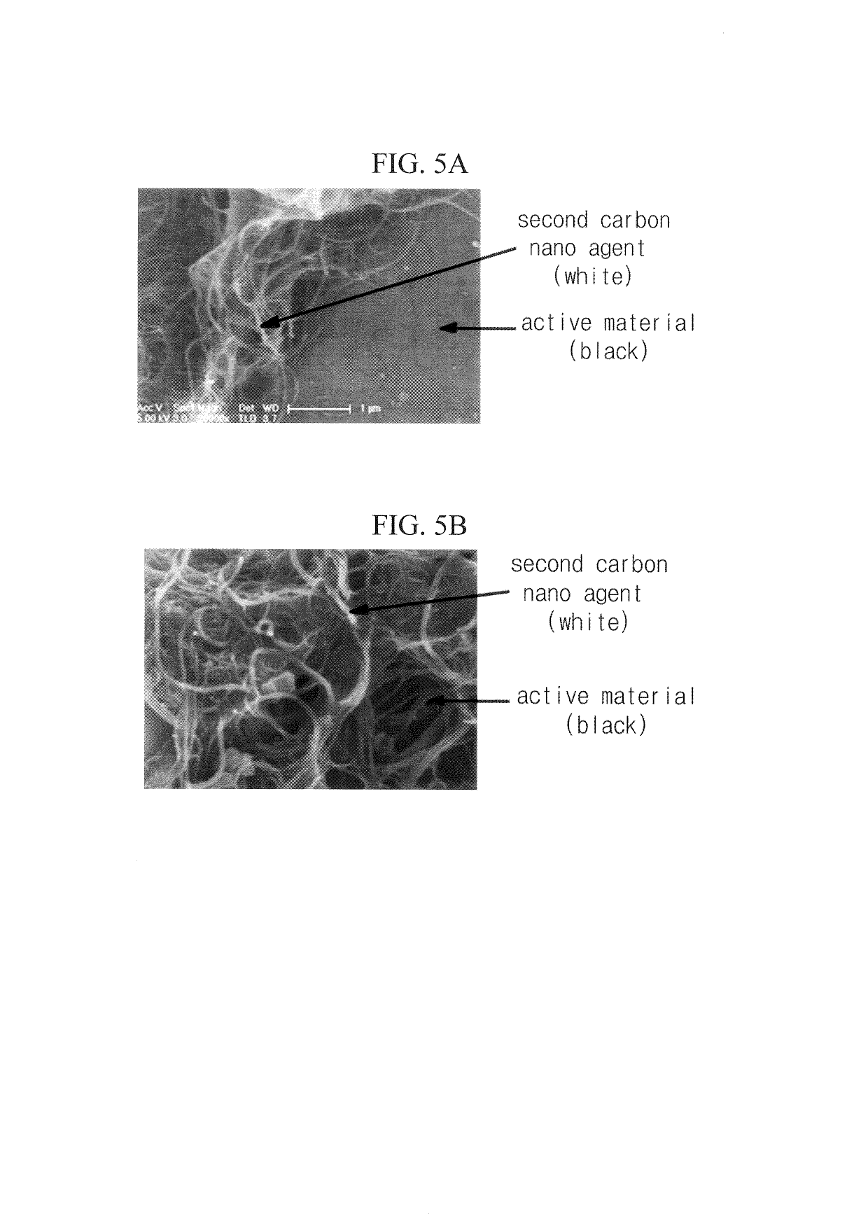

FIGS. 5A and 5B are microscopic photographic images of a second carbon nano conductive agent as a conductive agent for a secondary battery constructed with an embodiment of the present invention.

As shown in FIGS. 5A and 5B, the second carbon nano conductive agent is generally dispersed between active materials. That is to say, the second carbon nano conductive agent having the second diameter that that is relatively large is generally dispersed to be spaced apart from the surface of active material.

### EXAMPLES

Basically, a first carbon nano conductive agent (carbon nanotubes) having a first diameter and a second carbon nano conductive agent (carbon nanotubes) having a second diameter were used as the conductive agent, and the diameter ratio of the first diameter to the second diameter ranges from 1:2 to 1:10.

In practice, the first carbon nano conductive agent having the first diameter in a range of approximately 10 nm to approximately 30 nm was used, and the second carbon nano conductive agent having the second diameter in a range of approximately 30 nm to approximately 100 nm was used. Here, the specific surface area of the first carbon nano conductive agent is in a range of 150 to 350 m²/g, and the specific surface area of the second carbon nano conductive agent is smaller than 150 m²/g.

It is to be understood that the diameter and specific surface area of the first and second carbon nano conductive agents are not determined as certain numerical values in the course of manufacturing process, but are determined to be in relatively wide ranges of numerical values. That is to say, in order to further improve the high-rate discharge characteristic and cycle life characteristic of the secondary battery and the binding strength of the active material, it is necessary to use first and second carbon nano conductive agents having various diameters and specific surface areas, but the first and second carbon nano conductive agents that are currently commercially available in the market are classified to be in the range stated above.

As described above, the first and second carbon nano conductive agents used have purity of approximately 85% or greater.

### Example 1

A negative electrode was manufactured using 92 wt % of graphite as a negative active material, 5 wt % of a carbon nano conductive agent (consisting of 2.5 wt % of a first carbon nano conductive agent and 2.5 wt % of a second carbon nano conductive agent) as a conductive agent, and 3 wt % of styrene-butadiene rubber (SBR)/carboxymethyl cellulose (CMC) as a binder. After manufacture of the negative electrode in a cell to be tested, high-rate discharge and cycle life characteristics of the coin cell are tested. Here, the coin cell means a cell formed by inserting a separator between the negative electrode and a lithium metal and attaching the negative electrode and the lithium metal. In addition, the binding strength of the negative electrode is tested as follows. Here, the binding strength is obtained by measuring a force applied when a highly adhesive tape attached to a surface of the negative electrode is ripped off to separate the negative active material from a negative electrode current collector (e.g., a copper foil) on which the negative active material is formed.

### Example 2

Example 2 is substantially the same as Example 1, except that 5 wt % of a carbon nano conductive agent (consisting of 4 wt % of a first carbon nano conductive agent and 1 wt % of a second carbon nano conductive agent) was used as a conductive agent.

### Example 3

Example 3 is substantially the same as Example 1, except that 5 wt % of a carbon nano conductive agent (consisting of 1 wt % of a first carbon nano conductive agent and 4 wt % of a second carbon nano conductive agent) was used as a conductive agent.

### Example 4

Example 4 is substantially the same as Example 1, except that 5 wt % of a carbon nano conductive agent (consisting of 2 wt % of a first carbon nano conductive agent and 3 wt % of a second carbon nano conductive agent) was used as a conductive agent, and 3 wt % of carbon black was further added.

### Comparative Example 1

Comparative Example 1 is substantially the same as Example 1, except that 5 wt % of a first carbon nano conductive agent was used as a conductive agent.

### Comparative Example 2

Comparative Example 2 is substantially the same as Example 1, except that 5 wt % of a second carbon nano conductive agent was used as a conductive agent.

### Comparative Example 3

Comparative Example 3 is substantially the same as Example 1, except that 5 wt % of carbon black was used as a conductive agent.

Test results of Examples 1 to 4 and Comparative Examples 1 to 3 (initial capacity, high-rate discharge characteristic, cycle life characteristic and binding strength) are summarized in Table 1 below.

In Table 1, 0.2 C initial capacity values were obtained by charging cells 0.2 times of rated battery capacity for 5 hours, and 2 C high-rate discharge values were obtained by discharging cells 2 times of rated battery capacity for 30 minutes. In addition, 2 C 100 cycle life values or 2 C 200 cycle life values were obtained by charging cells 2 times of rated battery capacity for 30 minutes and discharging the cells 0.2 times of rated battery capacity for 5 hours.

TABLE 1

| | 0.2 C | 2 C | 2 C | 2 C | |
|---|---|---|---|---|---|
| | Initial | High-rate | 100 | 200 | Binding |
| | Capacity | discharge | cycle | cycle | strength |
| | (mAh/g) | (mAh/g) | life (%) | life (%) | (mm/fg) |
| Example | 356 | 327 | 83 | 75 | 4.5 |
| 1 | | | | | |
| Example | 358 | 332 | 75 | 68 | 4.1 |
| 2 | | | | | |
| Example | 354 | 315 | 79 | 75 | 4.4 |
| 3 | | | | | |
| Example | 355 | 311 | 73 | 64 | 3.9 |
| 4 | | | | | |
| Compar- | 353 | 320 | 67 | 59 | 3.4 |
| ative | | | | | |
| Example | | | | | |
| 1 | | | | | |
| Compar- | 352 | 307 | 66 | 63 | 3.6 |
| ative | | | | | |
| Example | | | | | |
| 2 | | | | | |
| Compa- | 350 | 302 | 62 | 48 | 2.1 |
| rative | | | | | |
| Example | | | | | |
| 3 | | | | | |

As shown in Table 1, 0.2 C initial capacity values of cells manufactured in Examples 1 to 4 were almost similar to or slightly higher than those in Comparative Examples 1 to 3.

In addition, 2 C high-rate discharge values of cells manufactured in Examples 1 to 4 were almost similar to or slightly higher than those in Comparative Examples 2 and 3, except for Comparative Example 1.

In particular, 2 C 100 cycle life values and 2 C 200 cycle life values of cells manufactured in Examples 1 to 4 were higher than those in Comparative Examples 1 to 3.

In addition, the cells manufactured in Examples 1 to 4 were far superior to those in Comparative Examples 1 to 3 in view of binding strength.

As described above, in accordance with an embodiment of the present invention, when the conductive agent includes 2.5 wt % of the first carbon nano conductive agent and 2.5 wt % of the second carbon nano conductive agent, the conductive agent includes 4 wt % of the first carbon nano conductive agent and 1 wt % of the second carbon nano conductive agent, the conductive agent includes 1 wt % of the first carbon nano conductive agent and 4 wt % of the second carbon nano conductive agent, and when the conductive agent includes 1 wt % of the first carbon nano conductive agent, 1 wt % of the second carbon nano conductive agent and 3 wt % of carbon black, the high-rate discharge and cycle life characteristics and the binding strength are generally improved.

### Example 5

A positive electrode was manufactured using 92 wt % of LiCoO₂ as a positive active material, 5 wt % of a first carbon nano conductive agent as a conductive agent and 3 wt % of polyvinylidene fluoride (PVDF) as a binder. After manufacture of the positive electrode in a cell to be tested, high-rate discharge and cycle life characteristics of the coin cell are tested. Here, the coin cell means a cell formed by inserting a separator between the negative electrode and a lithium metal and attaching the positive electrode and the lithium metal. In addition, the binding strength of the positive electrode is tested as follows. Here, the binding strength is obtained by measuring a force applied when a highly adhesive tape attached to a surface of the positive electrode is ripped off to separate the positive active material from a positive electrode current collector (e.g., an aluminum foil) on which the positive active material is formed.

### Example 6

Example 6 is substantially the same as Example 5, except that 5 wt % of a carbon nano conductive agent (consisting of 2.5 wt % of a first carbon nano conductive agent and 2.5 wt % of a second carbon nano conductive agent) was used as a conductive agent.

### Example 7

Example 7 is substantially the same as Example 5, except that 1 wt % of a first carbon nano conductive agent and 1 wt % of a second carbon nano conductive agent and 3 wt % of carbon black were used as a conductive agent.

### Comparative Example 4

Comparative Example 4 is substantially the same as Example 5, except that 5 wt % of carbon black was used as a conductive agent.

Test results of Examples 5 to 7 and Comparative Example 4 (initial capacity, high-rate discharge characteristic, cycle life characteristic and binding strength) are summarized in Table 2 below.

TABLE 2

| | 0.2 C | 2 C | | |
|---|---|---|---|---|
| | Initial | High-rate | 1 C | Binding |
| | Capacity | discharge | 100 cycle | strength |
| | (mAh/g) | (mAh/g) | life (%) | (mm/fg) |
| Example 5 | 157 | 120 | 83 | 1.6 |
| Example 6 | 155 | 129 | 89 | 2.4 |
| Example 7 | 154 | 124 | 79 | 1.8 |
| Comparative | 152 | 105 | 64 | 0.9 |
| Example 4 | | | | |

As described above, in accordance with an embodiment of the present invention, when the conductive agent includes 5 wt % of the first carbon nano conductive agent, the conductive agent includes 2.5 wt % of the first carbon nano conductive agent and 2.5 wt % of the second carbon nano conductive agent, and when the conductive agent includes 1 wt % of the first carbon nano conductive agent, 1 wt % of the second carbon nano conductive agent and 3 wt % of carbon black, the high-rate discharge and cycle life characteristics and the binding strength are generally improved.

More specifically, 0.2 C initial capacity values of cells manufactured in Examples 5 to 7 were almost similar to or slightly higher than in Comparative Example 4. 2 C 100 cycle life values and 2 C 200 cycle life values of cells manufactured in Examples 5 to 7 were higher than those in Comparative Example 4.

Even though embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A secondary battery including an electrode comprising an active material, a conductive agent and a binder, the conductive agent comprising:
a first carbon nano conductive agent having a first diameter; and
a second carbon nano conductive agent having a second diameter greater than the first diameter.

2. The secondary battery of claim 1, wherein a mixing ratio by weight of the first carbon nano conductive agent to the second carbon nano conductive agent ranges from 1:0.2 to 1:5.

3. The secondary battery of claim 1, wherein a diameter ratio of the first diameter to the second diameter ranges from 1:2 to 1:10.

4. The secondary battery of claim 1, wherein a diameter ratio of the first diameter to the second diameter ranges from 1:2 to 1:6.

5. The secondary battery of claim 1, wherein the first and second carbon nano conductive agents have the first and second diameters ranging from 1 nm to 200 nm, respectively.

6. The secondary battery of claim 1, wherein the first diameter is in a range of 5 nm to 50 nm and the second diameter is in a range of 10 nm to 150 nm.

7. The secondary battery of claim 1, wherein the first and second carbon nano conductive agents have an aspect ratio of 1 or greater.

8. The secondary battery of claim 1, wherein the first and second carbon nano conductive agents include carbon nano tubes, carbon nano fibers or mixtures thereof.

9. The secondary battery of claim 1, wherein the first and second carbon nano conductive agents include single-walled carbon nanotubes (SWNTs), multi-walled carbon nanotubes (MTWNTs), cup-stack type MTWNTs or mixtures thereof.

10. The secondary battery of claim 1, further comprising an additional conductive agent selected from the group consisting of natural graphite, artificial graphite, carbon black, acetylene black, ketjen black, carbon fiber, copper, nickel, aluminum, silver, polyphenylene derivatives and combinations thereof, and a mixing ratio of the first and second carbon nano conductive agents and the additional conductive agent ranging from 1:1 to 1:10.

11. The secondary battery of claim 10, wherein the first and second carbon nano conductive agents are contained in an amount of 1 to 90 wt % based on a total weight of the conductive agent.

12. The secondary battery of claim 1, wherein the first carbon nano conductive agent has a specific surface area of 50 to 500 m²/g, and the second carbon nano conductive agent has a specific surface area of less than 300 m²/g.

13. The secondary battery of claim 1, wherein a Raman ratio of the first and second carbon nano conductive agents is in a range of 0.01 to 2.

14. The secondary battery of claim 1, wherein the first and second carbon nano conductive agents have purity of greater than 85%.

15. The secondary battery of claim 1, wherein the first carbon nano conductive agent has a specific weight of 0.01 to 0.1 g/cm³, and the second carbon nano conductive agent has a specific weight of 0.005 to 0.01 g/cm³.

16. The secondary battery of claim 1, wherein the first carbon nano conductive agent has a specific resistance of 0.01 to 0.03 Ω·cm, and the second carbon nano conductive agent has a specific resistance of 0.01 to 0.1 Ω·cm.

17. The secondary battery of claim 1, wherein the conductive agent is contained in an amount of less than 10 wt % based on a total weight of the electrode.

18. The secondary battery of claim 1, further comprising an additional conductive agent selected from the group consisting of natural graphite, artificial graphite, carbon black, acetylene black, ketjen black, carbon fiber, copper, nickel, aluminum, silver, polyphenylene derivatives and combinations thereof, and the additional conductive agent being contained in an amount of less than 10 wt % based on a total weight of the electrode.

19. The secondary battery of claim 1, wherein the first carbon nano conductive agent is dispersed on a surface of the active material and the second carbon nano conductive agent is dispersed between active materials to form a network of electrical conduction.

20. A secondary battery including an electrode, the electrode comprising:
an active material; and
a conductive agent comprising a first carbon nano conductive agent which has a first diameter and is dispersed on surfaces of molecules of the active material, and a second carbon nano conductive agent which has a second diameter different from the first diameter and is positioned between molecules of the active material and forms a network of electrical conduction between the molecules of the active material.
